(19) United States
(12) Patent Application Publication
(10) Pub. No.: US 2017/0341175 A1
(43) Pub. Date: Nov. 30, 2017

(54) METHOD AND DEVICE FOR ADDITIVELY MANUFACTURING AT LEAST A PORTION OF A COMPONENT

(71) Applicant: MTU Aero Engines AG, Muenchen (DE)

(72) Inventors: Alexander Ladewig, Bad Wiessee (DE); Joachim Bamberg, Dachau (DE); Benjamin Henkel, Muenchen (DE); Laura Buerger, Dachau (DE)

(21) Appl. No.: 15/600,934

(22) Filed: May 22, 2017

(30) Foreign Application Priority Data
May 25, 2016 (DE) DE102016209084.4

(51) Int. Cl. B23K 15/00; B23K 26/12; B33Y 10/00; B33Y 80/00; B33Y 30/00; B23K 26/342; B23K 15/10; B23K 103/02

(52) U.S. Cl. CPC B23K 15/0086; B23K 26/342; B23K 26/123; B23K 15/10; B33Y 10/00; B33Y 80/00; B33Y 30/00; B23K 2203/02

(57) ABSTRACT

A method for additively manufacturing at least a portion of a component, in particular a component of a turbomachine. The method includes the following steps: a) depositing at least one powder layer of a component material in powder form layer by layer onto a component platform in the region of a buildup and joining zone; b) locally solidifying the powder layer by selectively irradiating the same using at least one high-energy beam in the region of the buildup and joining zone, forming a component layer; c) lowering the component platform by a predefined layer thickness; and d) repeating steps a) through c) until completion of the component portion or of the component. At least one contour portion of at least one component layer is irradiated in a step b1) at least once by at least one high-energy beam in a way that allows the solidified powder layer to be locally heated, but not melted, and, in a subsequent step b2), irradiated by at least one high-energy beam in a way that allows the solidified powder layer-to be locally melted in the region of the contour portion. In addition, a device for implementing such a method.

This claims the benefit of German Patent Application DE 102016209084.4 filed May 25, 2016 and hereby incorporated by reference herein.

The present invention relates to a method and a device for additively manufacturing at least a portion of a component.

### BACKGROUND

A wide variety of methods and devices for manufacturing individual component portions or complete components are known. Additive or generative manufacturing methods (generally referred to as rapid manufacturing or rapid prototyping) are known in particular, where the component, which can be a component of a turbomachine or of an aircraft engine, for example, is built up layer by layer. Mainly metallic components, for example, are suited for manufacture by laser or electron beam melting processes. Such processes require at least one component material in powder form to be initially deposited layer by layer in the area of a buildup and joining zone to form a powder layer. The component material is subsequently locally solidified by at least one high-energy beam that feeds energy to the component material in the region of the buildup and joining zone, thereby melting the component material and forming a component layer. In these approaches, the high-energy beam is controlled as a function of information pertaining to the respective component layer to be produced. The layer information is typically generated from a 3D CAD body of the component and subdivided into individual component layers. Upon solidification of the melted component material, the component platform is lowered layer by layer by a predefined layer thickness. The mentioned steps are subsequently repeated until completion of the desired component region or the entire component. In principle, the component region or the component may thereby be manufactured on a component platform or on a part of the component or of the component region that has already been produced. The advantages of this additive manufacturing reside, in particular, in the ability to manufacture very complex component geometries having cavities, undercuts and the like in the course of one single process.

### SUMMARY OF THE PRESENT INVENTION

In this type of additive manufacturing, however, powder particles frequently stick to or are sintered onto the surface. This leads to very rough surfaces which, in turn, can negatively affect the strength of the manufactured components or component regions. Attempts are being made to smooth the surface by optimizing the process parameters. However, this does not suffice for various applications, particularly in the case of aeronautic and aerospace components. For that reason, mechanical or chemical postprocessing of the manufactured components or component regions is often required. This entails considerable time and expense. In addition, inner surfaces, in particular, are somewhat inaccessible or not at all accessible to conventional smoothing processes

It is an object of the present invention to provide a method and device of the species that will make it possible to additively manufacture component regions or complete components having an improved surface quality. It is also an object of the present invention to provide an additively manufactured component having an improved surface quality.

A first aspect of the present invention relates to a method for additively manufacturing at least one region of a component, in particular a component of a turbomachine, where at least the steps are carried out: a) depositing at least one powder layer of a component material in powder form layer by layer onto a component platform in the region of a buildup and joining zone; b) locally solidifying the powder layer by selectively irradiating the same using at least one high-energy beam in the buildup and joining zone region, forming a component layer; c) lowering the component platform by a predefined layer thickness; and d) repeating steps a) through c) until completion of the component region or the component. An improved surface quality is thereby achieved in accordance with the present invention in that at least one contour portion of at least one component layer is irradiated in a step b1) at least once by at least one high-energy beam in a way that allows the solidified powder layer to be locally heated, but not melted and irradiated, and, in a subsequent step b2), by at least one high-energy beam in a way that allows the solidified powder layer to be locally melted in the region of the contour portion. In other words, the present invention provides that at least a portion of the contour line of the component layer in step b1) be irradiated at least one time separately during the process of building up at least one component layer following the volume irradiation in step b) in a way that prevents the already solidified component material from initially being melted on again. Thus, the energy input by the at least one high-energy beam is controlled in a manner that allows the resulting temperature of the component layer in the region of the contour line to be as close as possible to the melting temperature of the respective component material, thus, for example, no more than 20 K, 10 K, 5 K, 2 K or less below the melting temperature, but that does not allow melting to occur again. This sudden heating of the contour line leads to a pressure surge that forces away powder particles directly adjacent to the surface. In a second step b2), this contour portion is remelted using conventional parameters, for example, i.e., parameters already used in this manner or used similarly to the volume irradiation in step b), i.e., heated above the melting temperature. At this point, there are no more powder particles in the melt pool, thereby reliably preventing these powder particles from any adhesion or trapping of the same and ensuring a suitably high surface quality. Generally, in these approaches, both steps b1) and b2) may merely be carried out for a contour portion that is particularly relevant to the surface quality, for a plurality of spaced apart and/or adjoining contour portions, or along the entire contour line of the component layer. In this manner, smooth surfaces are already achieved during the additive manufacturing process, thereby advantageously eliminating the need for additional postprocessing. In addition, even inner or enclosed surfaces are directly accessible. Further advantages reside in that any contamination caused by chemical agents or other foreign materials may be ruled out, and there is no risk of unwanted removal of material (dimensional accuracy). Moreover, the strength of the resulting component is advantageously enhanced.

One advantageous embodiment of the present invention provides for step b1) to be implemented at least twice before step b2). In other words, the at least one high-energy beam travels along the respective contour portion or the entire contour of the component layer at least two times or more in order to intensely heat the component material locally in this region, however, without melting the same. Powder particles adjacent to the surface are hereby very reliably forced away therefrom, it being possible for an especially high surface quality to be achieved in following step b2).

Further advantages will become apparent in that a direction of movement of the at least one high-energy beam along the contour portion is reversed following at least one execution of step b1) and preferably following each execution of step b1). In other words, it is provided that the at least one high-energy beam be moved in the first implementation of step b1) in a first direction along the respective contour portion or along the entire contour of the component layer, and, upon a repeated implementation of step b1), and/or, upon implementation of step b2), in a direction opposite the first direction along the respective contour portion or along the entire contour of the component layer. This makes it possible to very reliably ensure that the surface remains free of powder particles, at least until melting occurs again in step b2).

Further advantages will become apparent in that the at least one high-energy beam in steps b1) and b2) is operated at a power level that deviates at a maximum by ±10%, respectively that is reduced by up to 90%. In other words, the power of the at least one high-energy beam may be at least substantially maintained at a constant level during step b1) and step b2). This simplifies the control or regulation of the at least one high-energy beam and of the energy input thereof into the contour region of the component layer since the contour region, respectively the contour is already heated following step b1), so that, with the same energy input, a melting may be achieved in step b2). It may be alternatively or additionally provided for the at least one high-energy beam in step b1) and step b2) to be moved at different velocities along the contour portion. This provides another simple way of realizing the desired energy input in steps b1) and b2). The at least one high-energy beam is preferably moved in step b2) at a velocity that is less than that in step b1). For example, the at least one high-energy beam may be moved in step b1) at a velocity of 10 m/s, while, in step b2), it is only moved at a velocity of 5 m/s, 2 m/s, 1 m/s or less.

Further advantages will become apparent in that at least steps b1) and b2) are carried out in a protective gas atmosphere. Generally, any suitable gas or gas mixture, such as argon and/or nitrogen, that does not react with the component material under the process parameters, may be used as a protective gas atmosphere. Besides protecting the component layer from oxidation, such a protective gas atmosphere also makes an especially high surface quality possible. This is because the protective gas rapidly expands locally due to the local heating in step b1) and thus leads to a pressure surge that very reliably forces powder adjacent to the surface away therefrom.

Another advantageous embodiment of the present invention provides that steps b1) and b2) be carried out for at least two different contour portions and preferably for all contour portions of one individual component layer and/or for at least two component layers and preferably for each component layer. This makes it possible to qualitatively improve either only especially relevant surface regions of the component or the entire surface thereof, whereby the method may be performed very economically.

Further advantages will become apparent when steps b1) and b2) are carried out using at least one split high-energy beam and/or a plurality of high-energy beams simultaneously on different contour portions. This permits a simultaneous surface processing of two or more contour portions, making it advantageously possible to lower the time for processing and producing the component layer and thus the component region or the component.

Further advantages will become apparent when an electron beam and/or a laser beam are/is used as a high-energy beam. Component regions or components may be hereby manufactured whose mechanical properties at least substantially correspond to those of the component material. CO₂ lasers, Nd:YAG lasers, Yb fiber lasers, diode lasers or the like may be provided, for example, to produce the laser beam. Similarly, it may be provided for two or more electron beams or laser beams to be used to reduce the processing time and/or to be able to produce particularly large-area component layers.

A second aspect of the present invention relates to a device for additively manufacturing at least a portion of a component, in particular of a component of a turbomachine, the device including at least one coating device for depositing at least one powder layer of a component material in powder form onto a buildup and joining zone of a lowerable component platform, and at least one radiation source for generating at least one high-energy beam that may be used to locally solidify the powder layer in the buildup and joining zone region to form a component layer. An improved surface quality of the additively manufactured component region or component is made possible in accordance with the present invention in that the device includes a control device that is designed to control the radiation source in a way that allows at least one contour portion of at least one component layer to be irradiated in one step at least once by at least one high-energy beam in a way that allows the solidified powder layer to be locally heated, but not melted and, in a subsequent step, irradiated by at least one high-energy beam in a way that allows the solidified powder layer to be locally melted in the region of the contour portion. Within the scope of the present invention, the expression “designed to” is not only understood to be a control device that features the basic property for performing the mentioned steps, but that is specifically configured and adapted for also actually executing the mentioned steps. These additional steps during the buildup process make it possible to considerably reduce the surface roughness of the respective component layer(s) since powder particles initially adjacent to the surface may be forced away, and the contour of the component layer may be subsequently partially or completely remelted, without there being any particles present in the melt pool. The device may basically include a controllable and/or regulable radiation source or a plurality thereof to generate the high-energy beams required in each particular case. Special advantages will become apparent when the device is designed for implementing a method in accordance with the first inventive aspect. The features derived therefrom and the advantages thereof are to be inferred from the description of the first inventive aspect; advantageous embodiments of the first inventive aspect being considered to be advantageous embodiments of the second inventive aspect and vice versa.

A second aspect of the present invention relates to a component for a turbomachine, in particular a compressor component or a turbine component; a high surface quality of the component being ensured in accordance with the present invention in that it is obtained at least regionally or completely by a method according to the first inventive aspect and/or by a device according to the second inventive aspect. The features derived therefrom and the advantages thereof are to be inferred from the description of the first and second inventive aspect; whereby advantageous embodiments of the first and second inventive aspect are to be considered as advantageous embodiments of the third inventive aspect and vice versa.

### BRIEF DESCRIPTION OF THE DRAWINGS

Other features of the present invention will become apparent from the claims, the figures, and the Detailed Description. The features and combinations of features mentioned above in the Specification, as well as the features and combinations of features mentioned below in the Detailed Description and/or shown solely in the figures may be used not only in the particular stated combination, but also in other combinations, without departing from the scope of the present invention. Thus, variants of the present invention are also considered to have been included and disclosed herein that are not shown and explained explicitly in the figures, but proceed from and may be created by separate combinations of features from the stated variants. Variants and combinations of features are also considered to have been disclosed herein that, therefore, do not include all of the features of an originally formulated independent claim. In the drawing,

FIG. 1 shows a schematic view of an additively manufactured component layer, together with an enlarged detail view of a contour portion during irradiation by a high-energy beam;

FIG. 2 shows a schematic view of a component layer manufactured in accordance with the present invention;

FIG. 3 schematically shows an enlarged detail view of a contour portion shown in FIG. 2 during a first implementation of a method step b1);

FIG. 4 schematically shows an enlarged detail view of the contour portion shown in FIG. 2 during a second implementation of method step b1); and

FIG. 5 schematically shows an enlarged detail view of the contour portion shown in FIG. 2 during a method step b2).

### DETAILED DESCRIPTION

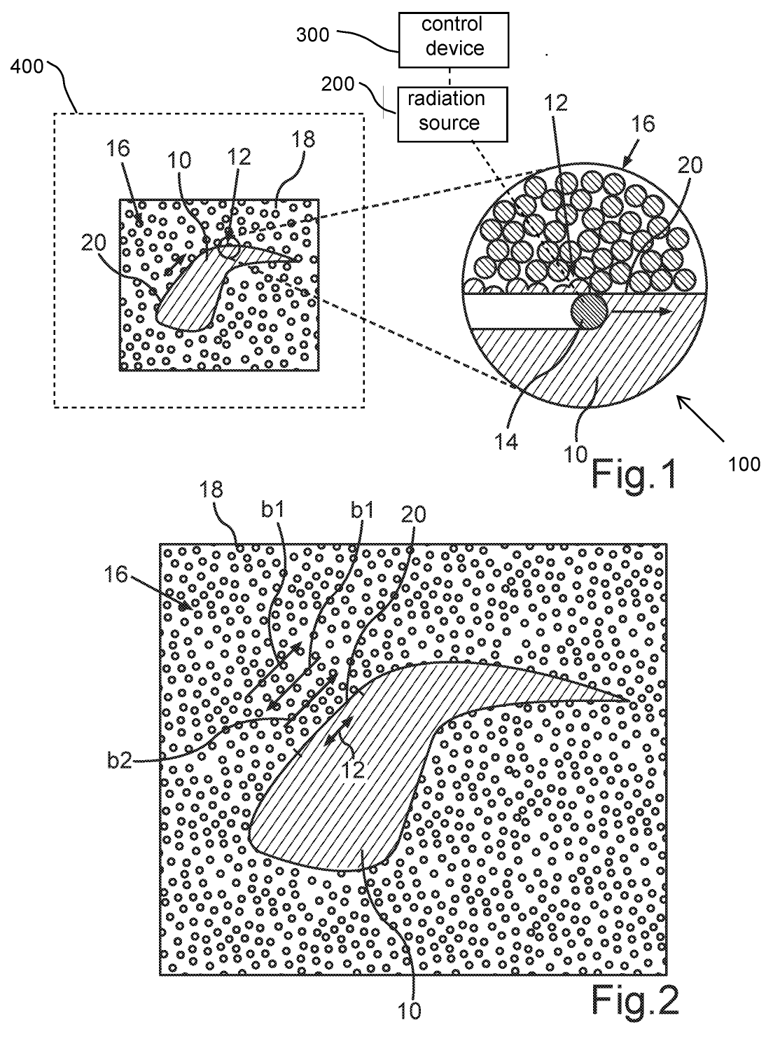

FIG. 1 shows a schematic plan view of an additively manufactured component layer 10 of a turbomachine component 100, such as turbine or compressor component, for a thermal gas turbine together with an enlarged detail view of a contour portion 12 during irradiation by a high-energy beam 14. To produce component layer 10, a powder layer 16 of a component material in powder form is initially deposited in layers in a generally known manner onto a component platform 400 shown schematically in the region of a buildup and joining zone 18. Powder layer 16 is subsequently locally solidified in that it is selectively irradiated by at least one high-energy beam 14, for example a laser beam, in the region of buildup and joining zone 18, forming component layer 10. The component platform is subsequently lowered by a predefined layer thickness, after which the mentioned steps are repeated until a component region or a complete component is finished. In the enlarged detail view, it is discernible that, upon irradiation of powder layer 16 in accordance with the arrows indicated along contour line 20, particles 16 adhere to the surface of component layer 10 and are melted in the process, respectively adhere to the surface. This leads to very rough surfaces which, in turn, negatively affect the strength of component layer 10 and require complex postprocessing, which, to some extent, is not possible, in particular for inner surface regions. The beam 14 is created by a radiation source 200, shown schematically, which is controlled by a control device 300.

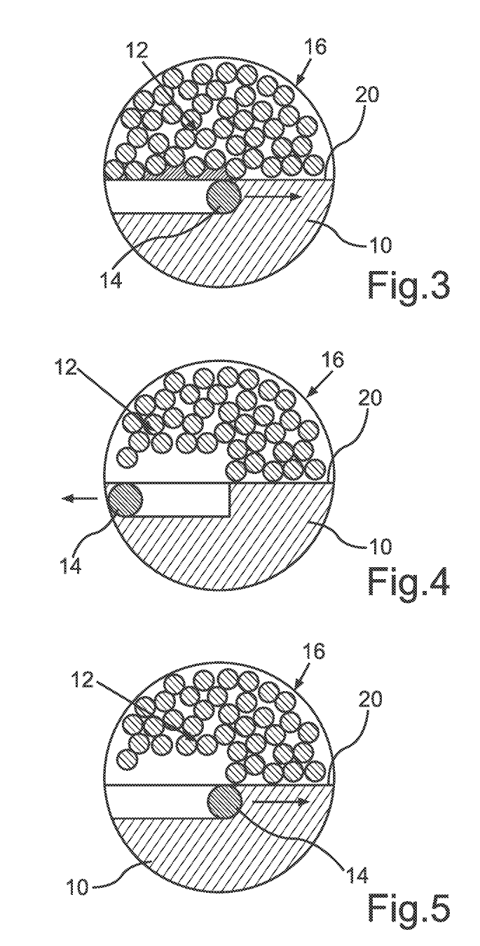

FIG. 2 shows a schematic plan view of a component layer 10 manufactured in accordance with the present invention. FIG. 2 is clarified in the following in connection with FIG. 3 through 5, which each schematically show enlarged detail views of contour portion 12 shown in FIG. 2 during the method steps characterized in FIG. 2 by arrows b1 and b2. Contour portion 12, which is required to have a high surface quality, is irradiated here in a first step b1 by at least one high-energy beam 14 in a way that allows solidified powder layer 16 to be locally heated, but not quite remelted. To this end, high-energy beam 14 is moved rapidly and with low linear energy along contour line 20 in contour portion 12 in accordance with first arrow b 1. Here, the sudden local heating at the surface of component layer 10 leads to a buildup of pressure of the generally optional protective gas (for example, argon), which fills an installation space of a device (not shown) used for implementing the method. This state is shown in FIG. 3. In a second step b1, counter line 20 is subsequently irradiated again in the opposite direction by high-energy beam 14 without any melting of component layer 10 occurring. This is shown in FIG. 4. It is discernible that the directly adjacent powder particles 16 are forced away from the surface or contour line 20 by the protective gas due to the resulting pressure surge. In a subsequent step b2, in which the direction of the high-energy beam is once again reversed, so that the irradiation takes place in the same direction as in first step b1, contour line 20 is then irradiated by high-energy beam 14 in a way that allows the solidified powder layer to be locally melted in the region of contour portion 12 using conventional parameters. This is shown in FIG. 5. At this stage, there are no more particles 16 in the melt pool, thereby reliably preventing adhesion and ensuring a high surface quality. Subsequently thereto, the described steps may be successively implemented along further contour portions 12 or along entire contour line 20. In steps b1 (2×) and b2, high-energy beam 14 is operated at a constant power, for example, at 300 W, however, moved at different velocities. In each of the two steps b1, high-energy beam 14 is moved at approximately 10 m/s, while, in step b2, it is moved more slowly, for example, at 1 m/s. The energy input and thus the heating or melting are hereby controlled. Alternatively or additionally, a plurality of high-energy beams 14 may be used for executing steps b1 and b2. It may also be provided for a plurality of high-energy beams 14 to be used to process a plurality of contour portions 12 at the same time. In addition, the mentioned steps b1 and b2 may be performed as needed for a plurality of component layers 10 or for every component layer 10. In this manner, smooth surfaces are already achieved during the additive manufacturing process, thereby advantageously eliminating the need for additional postprocessing. Even inner or enclosed surfaces are also directly accessible. Further advantages reside in that any contamination caused by chemical agents or other foreign materials may be ruled out, and there is no risk of unwanted removal of material (dimensional accuracy). Moreover, the strength of the resulting component is advantageously enhanced.

The parameter values indicated in the documents for defining process and measuring conditions for characterizing specific properties of the subject matter of the present invention are also considered as included within the scope of the present invention, even in the context of deviations—caused, for example, by measurement errors, system errors, DIN tolerances and the like.

### LIST OF REFERENCE NUMERALS

10 component layer
12 contour portion
14 high-energy beam
16 powder layer
18 joining zone
20 contour line
100 turbomachine component
200 radiation source
300 control device
400 platform

1-11. (canceled)

12. A method for additively manufacturing at least a portion of a component, the method comprising the following steps:
a) depositing at least one powder layer of a component material in powder form layer by layer onto a component platform in a region of a buildup and joining zone;
b) locally solidifying the powder layer by selectively irradiating the powder layer using at least one high-energy beam in the region of the buildup and joining zone, forming a component layer;
c) lowering the component platform by a predefined layer thickness; and
d) repeating steps a) through c) until completion of the component portion or of the component, wherein
at least one contour portion of the at least one component layer is irradiated in a step b1) at least once by the at least one high-energy beam in a way that allows the solidified powder layer to be locally heated, but not melted, and, in a subsequent step b2), irradiated by the at least one high-energy beam in a way that allows the solidified powder layer to be locally melted in the region of the contour portion.

13. The method as recited in claim 12 wherein step b1) is implemented at least twice before step b2) is carried out.

14. The method as recited in claim 13 wherein a direction of movement of the at least one high-energy beam along the contour portion is reversed following each execution of step b1).

15. The method as recited in claim 12 wherein a direction of movement of the at least one high-energy beam along the contour portion is reversed following at least one execution of step b1).

16. The method as recited in claim 12 wherein the at least one high-energy beam in step b1) and step b2) is operated at a power level that is reduced by up to 90%, or the at least one high-energy beam is moved in step b1) and step b2) at different velocities along the contour portion.

17. The method as recited in claim 12 wherein at least steps b1) and b2) are carried out in a protective gas atmosphere.

18. The method as recited in claim 12 wherein steps b1) and b2) are carried out for at least two different contour portions of the at least one contour portion.

19. The method as recited in claim 12 wherein steps b1) and b2) are carried out for all contour portions of the at least one contour portion of the one individual component layer of the at least one component layer, or for at least two component layers of the at least one component layer.

20. The method as recited in claim 19 wherein steps b1) and b2) are carried out for each component layer of the at least one component layers.

21. The method as recited in claim 12 wherein steps b1) and b2) are carried out using at least one split high-energy beam or a plurality of high-energy beams of the at least one high-energy beam simultaneously on different contour portions.

22. The method as recited in claim 12 wherein an electron beam and/or a laser beam is used as the at least one high-energy beam (14).

23. The method as recited in claim 12 wherein the component is a turbomachine component.

24. A device for additively manufacturing at least a portion of a component, the device comprising:
at least one coating device for depositing at least one powder layer of a component material in powder form to a buildup and joining zone of a lowerable component platform; and
at least one radiation source for generating at least one high-energy beam capable of locally solidifying the powder layer in the region of the buildup and joining zone to form a component layer;
a control device designed to control the radiation source in a way that allows at least one contour portion of at least one component layer to be irradiated in one step at least once by the at least one high-energy beam in a way that allows the solidified powder layer to be locally heated, but not melted, and, in a subsequent step, irradiated by the at least one high-energy beam in a way that allows the solidified powder layer to be locally melted in the region of the contour portion.

25. The device as recited in claim 24 designed for implementing the method as recited in claim 12.

26. A component for a turbomachine manufactured at least regionally or completely by the method as recited in claim 12.

27. A compressor component or a turbine component comprising the turbine component as recited in claim 26.
